(19) United States
(12) Patent Application Publication
(10) Pub. No.: US 2014/0241666 A1
(43) Pub. Date: Aug. 28, 2014

(54) OPTICAL COMMUNICATION MODULE

(71) Applicant: HON HAI PRECISION INDUSTRY CO., LTD., New Taipei (TW)

(72) Inventor: I-THUN LIN, New Taipei (TW)

(73) Assignee: HON HAI PRECISION INDUSTRY CO., LTD., New Taipei (TW)

(21) Appl. No.: 14/108,411

(22) Filed: Dec. 17, 2013

(30) Foreign Application Priority Data
Feb. 26, 2013 (TW) 102106624

(51) Int. Cl. G02B 6/42

(52) U.S. Cl. CPC G02B 6/4206
USPC 385/33

(57) ABSTRACT

An optical communication module includes a photoelectric conversion unit and a lens unit, the photoelectric conversion unit includes a substrate. The lens unit is fixed on the substrate. The optical communication module further includes a cylinder. The lens unit includes a blind hole faces to the substrate. The substrate includes a mounting hole, one end of the cylinder is fixed into the blind hole, another end of the cylinder is fixed into the mounting hole.

### BACKGROUND

1. Technical Field

The present disclosure relates to a communication module, and particularly to an optical communication module.

2. Description of Related Art

Optical communication modules typically include a photoelectric conversion unit, and a lens unit. The photoelectric conversion unit includes a substrate. In certain circumstances, when the lens unit aligns with the substrate, UV glue is used to fix the lens unit to the substrate. However, because the lens unit and optical fibers are connected through a pluggable manner, insertion of the optical fiber will cause a lateral pushing force between the lens unit and the substrate, therefore, the lens unit may be detached from the substrate.

Therefore, it is desirable to provide an optical communication module which can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an assembled, isometric view of an optical communication module, according to an exemplary embodiment.

FIG. 2 is an exploded, isometric view of the optical communication module of FIG. 1.

FIG. 3 is similar to FIG. 2, but viewed from another angle.

FIG. 4 is a cross sectional view taken along a line IV-IV of the optical communication module of FIG. 1.

### DETAILED DESCRIPTION

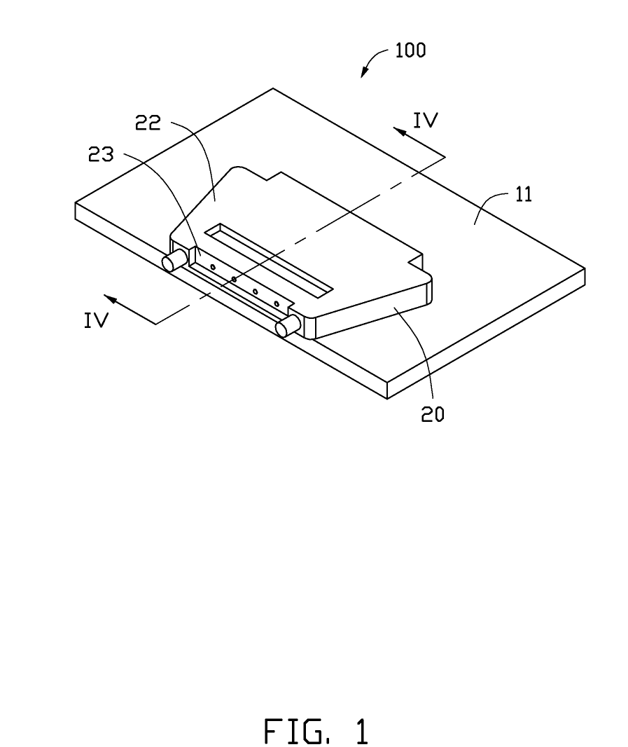

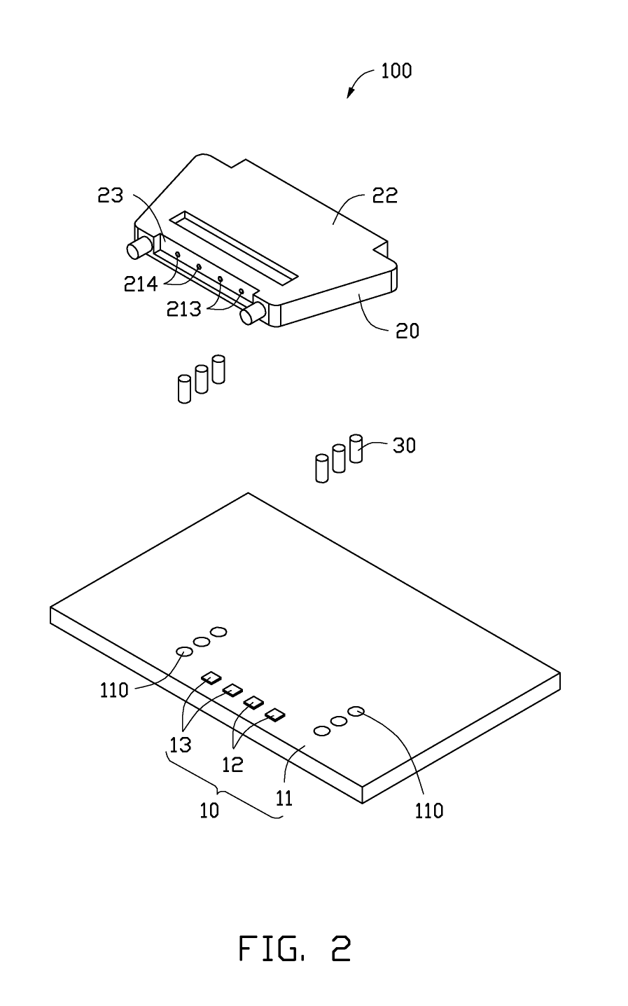

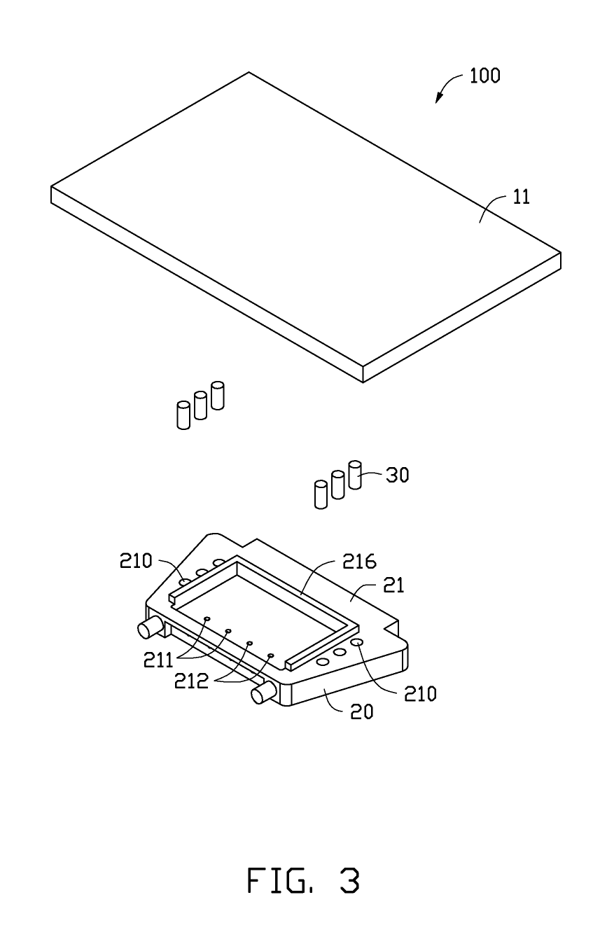

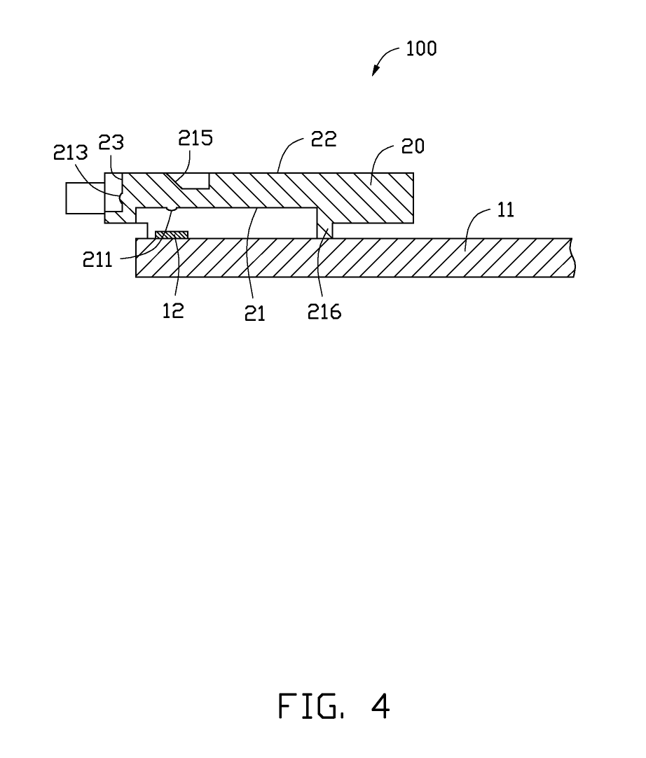

FIGS. 1-4 show an optical communication module 100, according to an embodiment. The optical communication module 100 includes a photoelectric conversion unit 10, a lens unit 20, and a cylinder 30. The cylinder 30 is configured to connect the photoelectric conversion unit 10 to the lens unit 20.

The photoelectric conversion unit 10 includes a substrate 11, a light emitting element 12 arranged on the substrate 11, and a light receiving element 13. The number of the light emitting element 12 and the light receiving element 13 is defined according to optical signals of the optical communication module 100. The substrate 11 is a circuit board, such as a rigid circuit board or a flexible circuit board. The light emitting element 12 is a light emitting diode (LED) or a laser diode (LD). The light receiving element 13 is a photo diode (PD).

The substrate 11 includes two rows of mounting holes 110, the mounting hole 110 can be a square hole, a circular hole or other shapes, preferably a circular hole. Each row includes at least one mounting hole 110. The mounting hole 110 can be a blind hole, a through hole, or a partially blind hole. The light emitting element 12 and the light receiving element 13 are arranged on an area between the two rows of mounting holes 110.

The lens unit 20 fixed on the substrate 11 includes a first surface 21 facing the substrate 11, a second surface 22 opposites to the first surface 21, and a third surface 23 connected to the first surface 21 and the second surface 22. The first surface 21 of the lens unit 20 includes two rows of blind holes 210, the number and arrangement of the blind holes 210 correspond with the mounting hole 110. Between two rows of the blind holes 210 on the first surface 21 includes two first lenses 211 and two second lenses 212, an optical axis of the first lens 211 and an optical axis of the second lens 212 are parallel to each other and are perpendicular to the substrate 11. In another embodiment, the number of first lens 211 and the second lens 212 can be increased depending on requirement. The number of first lenses 211 is equal to and corresponds to the number of the light emitting elements 12, the number of second lenses 212 is equal to and corresponds to the number of light receiving elements 13. The third surface 23 includes a third lens 213 and a fourth lens 214 separately corresponding to the first lens 211 and the second lens 212. An optical axis of the third lens 213 and an optical axis of the fourth lens 214 are parallel to each other and parallel to the substrate 11. A reflective surface 215 is formed hollowly toward the first surface 21 on the second surface 22. The optical axis of the first lens 211 and the optical axis of the third lens 213 perpendicular to each other on the reflective surface 215, and an angle between the first lens 211 and the reflective surface 215 is forty-five degrees. The optical axis of the second lens 212 and the optical axis of the fourth lens 214 are perpendicular to each other on the reflective surface 215, and an angle between the second lens 212 and the reflective surface 215 is forty-five degrees.

The first surface 21 includes a wall 216 positioned at an area between the first lens 211, the second lens 212, and the blind hole 210. The wall 216 is used to block viscous medium from flowing into the first lens 211 and the second lens 212.

Emitted light of the light emitting element 12 passes through the first lens 211 and reflects on the reflective surface 215. The emitted light is reflected by the reflective surface 215 then shines on the third lens 213, then the light is emitted from the third lens 213 and into optical fibers (not shown). Light in the optical fiber via the fourth lens 214 reflects on the reflective surface 215, then is emitted through the second lens 212, and received by the light receiving element 13.

The cylinder 30 is made of metal material, such as iron, aluminum, and copper, for example. A shape of the cylinder 30 corresponds to a shape of the blind hole 210 and the mounting hole 110. One end of the cylinder 30 is fixed into the blind hole 210, the other end of the cylinder 30 fixed into the mounting hole 110 via a viscous medium (glue or resin or other semi-solid medium with sticky properties). A diameter of the mounting hole 110 is greater than a diameter of the cylinder 30. A gap is generated between the cylinder 30 and the mounting hole 110, allowing the viscous medium to flow into the mounting hole 110 thereby increasing a contact area between the viscous medium and the substrate 11, thus a binding force between the cylinder 30, the lens unit 20, and the substrate 11 is increased.

In other embodiments, one end of the cylinder 30 fixed into the mounting hole 110 can be designed as a conical configuration and fit tightly with the mounting hole 110.

First, the cylinder 30 is fixed into the blind hole 210 then the lens unit 20 is fixed on the substrate 11. After that the cylinder 30 is extended into the mounting hole 110 aligning the lens unit 20 with the substrate 11. The viscous medium is injected into the gap between the cylinder 30 and the mounting hole 110. The viscous medium is guided by the cylinder 30 to flow between the lens unit 20 and the substrate 11. The lens unit 20 is fixed to the substrate 11 when the viscous medium cures.

The lens unit 20 and the substrate 11 of the optical communication module 100 are fixed via the cylinder 30, since the cylinder 30 has an large intensity, during the insertion process, the cylinder 30 is not easy to be broken or tilted, so that the lens unit 20 and the substrate 11 has a stronger lateral force.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. An optical communication module comprising a photoelectric conversion unit and a lens unit; the photoelectric conversion unit comprising a substrate, the lens unit fixed on the substrate; the optical communication module further comprising:
a cylinder;
a blind hole on the lens unit facing the substrate;
a mounting hole on the substrate;
wherein one end of the cylinder is fixed into the blind hole, another end of the cylinder fixed into the mounting hole.

2. The optical communication module of claim 1, wherein the cylinder is made of metal.

3. The optical communication module of claim 1, wherein a diameter of the mounting hole is greater than a diameter of the cylinder.

4. The optical communication module of claim 1, wherein the photoelectric conversion unit further comprises a light emitting element and a light receiving element.

5. The optical communication module of claim 4, wherein a surface of the lens unit faces the substrate comprises lenses coupling to the light emitting element and the light receiving element.

6. The optical communication module of claim 4, wherein the substrate is a rigid circuit board.

7. The optical communication module of claim 4, wherein the substrate is a flexible circuit board.

8. The optical communication module of claim 4, wherein the light emitting element is a light emitting diode (LED) or a laser diode (LD); the light receiving element is a photo diode (PD).

9. The optical communication module of claim 4, wherein between the lens and the blind hole comprises a wall.

10. The optical communication module of claim 1, wherein between the cylinder, the blind hole, and the mounting hole comprises a viscous medium.

11. The optical communication module claim 9, wherein the viscous medium is glue or resin.
